(19) United States
(12) Patent Application Publication
(10) Pub. No.: US 2024/0071261 A1
(43) Pub. Date: Feb. 29, 2024

(54) PRESSURE SENSITIVE ADHESIVE LABEL

(71) Applicant: LINTEC CORPORATON, Tokyo (JP)

(72) Inventor: Ayaka SETO, Tokyo (JP)

(21) Appl. No.: 18/320,607

(22) Filed: May 19, 2023

(30) Foreign Application Priority Data
Aug. 26, 2022 (JP) 2022-134652

(51) Int. Cl. G09F 3/10; G09F 3/02

(52) U.S. Cl. CPC G09F 3/10; G09F 3/02; G09F 2003/0241

(57) ABSTRACT

There is provided a pressure sensitive adhesive label, including: a pressure sensitive adhesive layer, a base material layer, and a detachment coat layer in this order, in which the detachment coat layer is formed of a composition for forming a detachment coat layer that contains an aqueous polyester-based resin, and the aqueous polyester-based resin has an acid value of 10 KOHmg/g or more, and a glass transition temperature Tg of 0° C. or more and 70° C. or less.

### CROSS-REFERENCE TO RELATED APPLICATION

This application claims priority to Japanese Patent Application No. 2022-134652 filed on Aug. 26, 2022, the disclosure of which is hereby incorporated in its entirety by reference.

### BACKGROUND OF THE INVENTION

### Field of the Invention

The present disclosure relates to a pressure sensitive adhesive label.

### Description of Related Art

In recent years, there has been a strong demand for recycling of polyester-based containers due to issues such as environmental pollution and exhaustion of petroleum resources. Among polyester-based containers, recycling of polyethylene terephthalate (PET) bottles has been particularly demanded.

In material recycling of polyester-based containers, the containers are generally crushed into flakes, and heated and melted for homogenization as a whole. The resulting recycled resin is used as a material of polyester-based containers.

Generally, polyester-based containers such as PET bottles are provided with a pressure sensitive adhesive label (also referred to as a label) attached thereto, on the surface of which various information is recorded. In material recycling of such a polyester-based container such as a PET bottle with a label thereon, if a resin base material of the label and a resin constituting the polyester-based container do not have compatibility with each other, the resin base material and a pressure sensitive adhesive of the label act as foreign matters, thereby causing a problem that the mechanical properties of a recycled resin deteriorate. Hence, in such a case, the label attached to the polyester-based container needs to be peeled off before the container is crushed into flakes, and heated and melted. However, the operation of peeling off a label from a polyester-based container is extremely burdensome and laborious and raises recycling processing costs, which is disadvantageous in terms of workability and economics.

In regard to this problem, for example, Patent Document 1 below discloses a pressure sensitive adhesive label that includes a polyester-based resin base material; a coat layer on a surface of the base material; and a polyester-based pressure sensitive adhesive layer on the opposite surface of the base material. The base material has compatibility with a polyester-based container, i.e., an adherend. The coat layer has printability and can be detached from the base material by immersion washing with an alkaline aqueous solution.

Patent Document 1 also discloses that such configuration enables a surface coat and an ink layer to be easily detached by immersion washing with an alkaline aqueous solution and that using a polyester-based pressure sensitive adhesive made of the same material as that of a resin molded article such as a PET bottle enables the molded article such as a PET bottle to be processed for recycling without a necessity of peeling off the label therefrom.
[Patent Document 1] JP-A-2000-010489

As described above, if a polyester-based container such as a PET bottle is recycled while its polyester-based pressure sensitive adhesive label with a print thereon is attached to the adherend, the print portion works as an impurity, although the base material and the pressure sensitive adhesive layer of the polyester-based pressure sensitive adhesive label have high compatibility with the adherend. The recycling efficiency is thus reduced. It hence becomes necessary to detach the print portion during the washing with an alkaline aqueous solution, and there is a demand for a pressure sensitive adhesive label that can release a print portion in a short time and can be subsequently processed for recycling while being attached to its adherend.

On the other hand, in the case of containers made of glass, glass containers cannot be processed for recycling with a pressure sensitive adhesive label attached thereto. In the case of containers made of plastic, plastic containers cannot be processed for recycling with a pressure sensitive adhesive label attached thereto if the pressure sensitive adhesive label is made using a material having low compatibility with the container. In such cases, the containers are recycled after peeling off the pressure sensitive adhesive labels therefrom, and there is a demand for separate recycling of peeled off labels. Also in this case, the print portion works as an impurity and it is necessary to detach the print portion in a short time.

Regardless of the above-mentioned materials of the containers or the material of the pressure sensitive adhesive label, good printability is required when information is to be printed on the label.

The present disclosure has been made to solve the problems above and provides a pressure sensitive adhesive label, from which a print portion can be detached (released) in an alkaline aqueous solution at a low temperature (about 70° C.) in a short time and can be recycled either in a state of being attached to an adherend or in a state of having been peeled off from an adherend. The present disclosure also provides a pressure sensitive adhesive label excellent in printability.

The inventor has intensively studied and completed the present disclosure, that is, a pressure sensitive adhesive label including: a pressure sensitive adhesive layer; a base material layer; and a detachment coat layer in this order, in which the detachment coat layer is formed of a composition for forming a detachment coat layer that contains an aqueous polyester-based resin having an acid value within a predetermined numerical range and a glass transition temperature Tg within a predetermined numerical range. Thereby, a print portion can be detached (released) in an alkaline aqueous solution at a low temperature (about 70° C.) in a short time, and the pressure sensitive adhesive label can be recycled either in a state of being attached to a container or in a state of having been peeled off from a container depending on the material of the container. Further, the pressure sensitive adhesive label can be excellent in printability.

### SUMMARY OF THE INVENTION

The present disclosure provides the following items.

(1) A first aspect of the present disclosure is a pressure sensitive adhesive label, including: a pressure sensitive adhesive layer, a base material layer, and a detachment coat layer in this order, in which the detachment coat layer is formed of a composition for forming a detachment coat layer that contains an aqueous polyester-based resin, and the aqueous polyester-based resin has an acid value of 10 KOHmg/g or more, and a glass transition temperature Tg of 0° C. or more and 70° C. or less.
(2) A second aspect of the present disclosure is the pressure sensitive adhesive label according to the item (1), in which the aqueous polyester-based resin has a number average molecular weight of 1,000 or more and 15,000 or less.
(3) A third aspect of the present disclosure is the pressure sensitive adhesive label according to the item (1), in which the aqueous polyester-based resin has a carboxyl group.
(4) A fourth aspect of the present disclosure is the pressure sensitive adhesive label according to the item (1), further including: an alkali-insoluble coat layer that is on the detachment coat layer facing the base material layer.
(5) A fifth aspect of the present disclosure is the pressure sensitive adhesive label according to the item (4), in which the alkali-insoluble coat layer is made of a urethane-modified polyester resin.
(6) A sixth aspect of the present disclosure is the pressure sensitive adhesive label according to the item (4), in which the alkali-insoluble coat layer contains a crosslinked resin.

The present disclosure can provide a pressure sensitive adhesive label that enables a print portion to be detached (released) in an alkaline aqueous solution at a low temperature (about 70° C.) in a short time; can be recycled either in a state of being attached to a container or in a state of having been peeled off from a container; and has excellent printability.

### BRIEF DESCRIPTION OF THE DRAWINGS

FIG. 1 is a schematic cross-section of a pressure sensitive adhesive label according to an embodiment of the present disclosure.

FIG. 2 is a schematic cross-section of a pressure sensitive adhesive label according to another embodiment of the present disclosure.

### DESCRIPTION OF THE INVENTION

Hereinafter, embodiments for carrying out the present disclosure (hereinafter, simply referred to as “the present embodiments”) will be described in detail. The present embodiments described below are illustrative examples of the present disclosure, and it is not intended to limit the present disclosure to the following description. The present disclosure can be appropriately modified within the scope of the gist thereof.

In the drawings, the same elements are denoted by the same reference numerals, and a repetitive description of such elements will be omitted. The positional relationship such as top, bottom, left, and right are based on the positional relationship indicated in the figures unless otherwise specified. The dimension ratio of a figure is not limited to the ratio illustrated in the figure.

Herein, operations, physical properties and the like are measured at room temperature (20° C. or more and 25° C. or less) and at a relative humidity of 45% RH or more and 55% RH or less unless otherwise specified.

A pressure sensitive adhesive label is attached to various containers such as a glass-based container including a glass bottle and a plastic-based container including a PET bottle. Hereinafter, a PET bottle exemplifies an adherend, to which a pressure sensitive adhesive label is attached. The pressure sensitive adhesive label may have any shape, but generally it is rectangular when viewed in the direction in which layers of the pressure sensitive adhesive label are stacked. Alternatively, the pressure sensitive adhesive label may have a triangular shape or a circular shape. A pressure sensitive adhesive layer is disposed on the entire surface of a base material layer, for example.

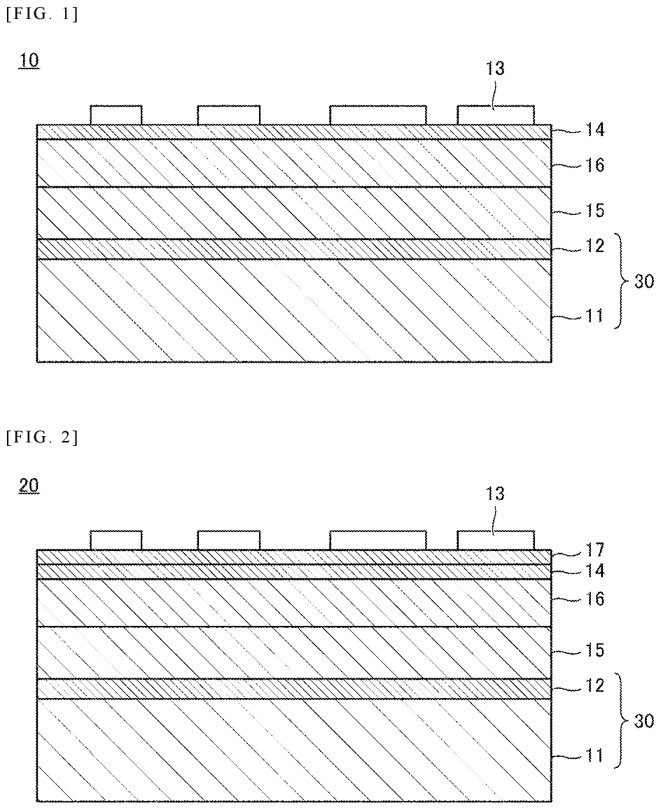

A configuration of the pressure sensitive adhesive label will be described below with reference to FIG. 1.

FIG. 1 is a schematic cross-section of a pressure sensitive adhesive label 10 according to an embodiment of the present disclosure. As shown in FIG. 1, the pressure sensitive adhesive label 10 according to the embodiment of the present disclosure includes a print portion 13, a detachment coat layer 14, a base material layer 16, a pressure sensitive adhesive layer 15, and a release liner 30 in this order from the top. The release liner 30 is formed by a release agent layer 12 and a release base material layer 11 that are disposed in this order. The detachment coat layer 14 decomposes and dissolves when it comes into contact with alkaline water and detaches (releases) the print portion 13 from the pressure sensitive adhesive label 10. Thereby, the detached print portion 13 floats, so that it can be easily collected. Incidentally, the pressure sensitive adhesive label 10 may have another functional layer such as a primer layer between the layers or on the surfaces thereof.

FIG. 2 is a schematic cross-section of a pressure sensitive adhesive label 20 according to another embodiment of the present disclosure. The pressure sensitive adhesive label 20 includes an alkali-insoluble coat layer 17 that is provided between the print portion 13 and the detachment coat layer 14 of the pressure sensitive adhesive label 10. That is, the pressure sensitive adhesive label 20 has the alkali-insoluble coat layer 17 on the detachment coat layer 14 facing the base material layer 16. The alkali-insoluble coat layer 17 does not dissolve during the release with alkali and remains as it is, as resin, so that the alkali-insoluble coat layer 17 will be detached together with the print portion 13 that is on the alkali-insoluble coat layer 17, in a film form. That is, the print portion 13 will not be detached in small pieces but in a form larger than a certain size, so that the print portion 13 can be easily collected. Although it is mentioned above that the alkali-insoluble coat layer 17 is on the detachment coat layer 14, it means not only that the detachment coat layer 14 and the alkali-insoluble coat layer 17 are adjacent to each other but also that another layer (not shown) may exist between the detachment coat layer 14 and the alkali-insoluble coat layer 17. A preferred arrangement is that the detachment coat layer 14 and the alkali-insoluble coat layer 17 are adjacent to each other.

Further, it is preferred that there is no other detachment coat layer between the base material layer 16 and the pressure sensitive adhesive layer 15. One suitable arrangement is that the base material layer 16 and the pressure sensitive adhesive layer 15 are adjacent to each other. By arranging such that there is no other detachment coat layer between the base material layer 16 and the pressure sensitive adhesive layer 15, and the detachment coat layer 14 is provided between the base material layer 16 and the print portion 13 or between the base material layer 16 and the alkali-insoluble coat layer 17, the base material layer 16 will not be released from a polyester-based container (the adherend) when the pressure sensitive adhesive label 10(20) is brought into contact with alkaline water in a recycling processing in which the pressure sensitive adhesive label 10(20) is recycled while being attached to a PET bottle (the polyester-based container). The pressure sensitive adhesive layer 15 and the base material layer 16 thus remain attached to the polyester-based container. Hence, both the base material layer 16 and the pressure sensitive adhesive layer 15 can be recycled at once.

In the case that the pressure sensitive adhesive label 10(20) is not recycled together with the container, the pressure sensitive adhesive label 10(20) is first peeled off from the container and is brought into contact with alkaline water to detach the print portion 13 (and the alkali-insoluble coat layer 17) in the same manner as described above before being processed for recycling.

The concept of “a label” includes what are referred to as a film, a sheet, a tape and the like.

Hereinafter, components constituting the present disclosure will be described.

<Print Portion>

The print portion 13 is a layer for displaying information and may be any type of layer. The print portion 13 may be formed in any manner. For example, the print portion 13 may be formed by flexographic printing, offset printing, relief printing, gravure printing, screen printing, thermal transfer printing or the like.

The information to be displayed on the print portion 13 may be, for example, a letter, a number, a picture, a photograph, a graph or the like or a combination thereof.

<Alkali-Insoluble Coat Layer>

The alkali-insoluble coat layer 17 is a layer that is disposed under the print portion 13. Since the alkali-insoluble coat layer 17 will not dissolve during the release with alkali and remain as it is, as resin, the print portion 13 will be detached in a film form. Thereby, the print portion 13 can be easily collected. Hence, the alkali-insoluble coat layer 17 is preferably disposed on a print surface.

The alkali-insoluble coat layer 17 includes a resin as a main component. The term “main component” as used herein means that it occupies 60% by mass or more (the upper limit: 100% by mass) of the alkali-insoluble coat layer 17. The resin is insoluble in alkali. The term “insoluble in alkali” as used herein means, for example, that the dissolution amount is 20% by mass or less (the lower limit: 0% by mass), preferably 10% by mass or less, more preferably 5% by mass or less, and particularly preferably 1% by mass or less, in a 1.5% by mass aqueous sodium hydroxide solution at 70° C. (pH 13.6).

The alkali-insoluble coat layer 17 may be formed of a resin such as a urethane modified polyester resin, an acrylic acid ester (co)polymer, an epoxy resin, or a polyamide resin, for example. Among them, the alkali-insoluble coat layer 17 is preferably formed of a urethane modified polyester resin since high print adhesion can be obtained. The resin that forms the alkali-insoluble coat layer 17 preferably has an acid value of 3 KOHmg/g or less, more preferably 2 KOHmg/g or less, since the solubility in alkaline water can be lowered. As long as the acid value is within the numerical ranges above, a polyester-based resin can also be used as the resin to form the alkali-insoluble coat layer 17.

Examples of the urethane modified polyester resin include, but not limited to, a polymer (polyester urethane) obtained by reaction between a polyisocyanate compound and a polyester polyol having a hydroxyl group at a terminal of a polymer obtained by condensation polymerization of a polyol and a carboxylic acid component.

Examples of the polyisocyanate compound include, but not limited to, trimethylene diisocyanate, tetramethylene diisocyanate, hexamethylene diisocyanate, isophorone diisocyanate, xylylene diisocyanate, phenylene diisocyanate, tolylene diisocyanate, diphenylmethane diisocyanate, and naphthalene diisocyanate.

The urethane modified polyester resin preferably has a number average molecular weight (Mn) of 2,000 or more and 100,000 or less, and more preferably 5,000 or more and 50,000 or less. The number average molecular weight (Mn) as used herein is a polystyrene-converted number average molecular weight measured by Gel Permeation Chromatography (GPC).

The urethane modified polyester resin preferably has a glass transition temperature of 100° C. or less, and more preferably −40° C. or more and 100° C. or less, for example.

A commercially available product may be used for the urethane modified polyester resin. Examples of the commercially available product include, but not limited to, the VYLON series (trade name) manufactured by TOYOBO CO., LTD. Preferably, VYLON UR-2300 (the number average molecular weight: 32,000, Tg: 18° C., the acid value: less than 1 KOHmg/g), VYLON UR-3200 (the number average molecular weight: 40,000, Tg: −3° C., the acid value: less than 1 KOHmg/g), VYLON UR-3210 (the number average molecular weight: 40,000, Tg: −3° C., the acid value: less than 1 KOHmg/g), VYLON UR-6100 (the number average molecular weight: 25,000, Tg: −30° C., the acid value: less than 1 KOHmg/g), VYLON UR-8200 (the number average molecular weight: 25,000, Tg: 73° C., the acid value: less than 1 KOHmg/g), VYLON UR-8300 (the number average molecular weight: 30,000, Tg: 23° C., the acid value: less than 1 KOHmg/g), and VYLON UR-8700 (the number average molecular weight: 32,000, Tg: −22° C., the acid value: less than 1 KOHmg/g) can be used, for example.

The resin content of the alkali-insoluble coat layer 17 is preferably 80% by mass or more and 100% by mass or less, and more preferably 90% by mass or more and 99% by mass or less.

The resin that is contained in the alkali-insoluble coat layer 17 is preferably a crosslinked resin. It is preferred that the resin is a crosslinked resin since the solubility of the alkali-insoluble coat layer 17 in alkaline water is further reduced. The resin can be crosslinked by adding a crosslinking agent in a composition for forming an alkali-insoluble coat layer described later, which is for forming the alkali-insoluble coat layer 17. The crosslinking agent herein is an appropriately selected crosslinking agent that reacts with a crosslinkable reactive group in the resin. In particular, by selecting a crosslinking agent that reacts with a carboxyl group, which is a crosslinkable reactive group, remaining carboxyl groups in the resin can be crosslinked. The solubility in alkaline water is thereby further reduced, which is preferable.

Examples of the crosslinking agent that can react with a carboxyl group include, but not limited to, an isocyanate-based crosslinking agent, an epoxy-based crosslinking agent, an aziridine-based crosslinking agent, a metal chelate-based crosslinking agent.

Examples of the isocyanate-based crosslinking agent include, but not limited to, diisocyanate compounds including: aliphatic diisocyanates such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,2,4-trimethylhexamethylene diisocyanate, 2,4,4-trimethylhexamethylene diisocyanate, lysine diisocyanate, lysine ester triisocyanate, 1,6,11-undecane triisocyanate, 1,3,6-hexamethylene triisocyanate, trimethylhexamethylene diisocyanate, and decamethylene diisocyanate; aromatic diisocyanates such as tolylene diisocyanate and xylylene diisocyanate; cycloaliphatic diisocyanates such as isophorone diisocyanate; as well as isocyanate derivatives including: an adduct of a diisocyanate compound with a polyol compound such as trimethylolpropane; a biuret and an isocyanurate of a diisocyanate compound; and a bifunctional diisocyanate compound.

Examples of the epoxy-based crosslinking agent include, but not limited to, 1,3-bis(N,N′-diglycidylaminomethyl)cyclohexane, N,N,N′, N′-tetraglycidyl-m-xylylenediamine, ethylene glycol diglycidyl ether, 1,6-hexanediol diglycidyl ether, trimethylolpropane diglycidyl ether, diglycidylaniline, and diglycidyl amine.

Examples of the aziridine-based crosslinking agent include, but not limited to, diphenylmethane-4,4′-bis(1-aziridinecarboxamide), trimethylolpropane tri-β-aziridinyl propionate, tetramethylolmethane tri-β-aziridinyl propionate, toluene-2,4-bis(1-aziridine carboxamide), triethylene melamine, bisisophthaloyl-1-(2-methylaziridine), tris-1-(2-methylaziridine) phosphine, and trimethylolpropane tri-β-(2-methylaziridine) propionate.

Examples of the metal chelate-based crosslinking agent include, but not limited to, chelate compounds in which a metal atom is aluminum, zirconium, titanium, zinc, iron, tin or the like. In terms of performance, an aluminum chelate compound is preferred. Examples of the aluminum chelate compound include, but not limited to, diisopropoxyaluminum monooleyl acetoacetate, monoisopropoxyaluminum bisoleyl acetoacetate, monoisopropoxyaluminum monooleate monoethyl acetoacetate, diisopropoxyaluminum monolauryl acetoacetate, diisopropoxyaluminum monostearyl acetoacetate, and diisopropoxyaluminum monoisostearyl acetoacetate.

Among them, the crosslinking agent is preferably an isocyanate-based crosslinking agent since the crosslinked coat layer can have high print adhesion.

The crosslinking agent may be used singly or in combination of two or more.

The crosslinking agent is added in an amount appropriately set in consideration of the amount of a crosslinkable reactive group in the resin and the like. The crosslinking agent is preferably added in an amount of 0.01 parts by mass or more and 10 parts by mass or less, and more preferably 0.1 parts by mass or more and 5 parts by mass or less, per 100 parts by mass of the resin.

The alkali-insoluble coat layer 17 preferably has a thickness of 0.05 μm or more and 1 μm or less, and more preferably 0.05 μm or more and 0.5 μm or less, in consideration of the ease of collection of the print portion 13 and thin film properties.

The alkali-insoluble coat layer 17 may contain an additive such as a catalyst, an ultraviolet absorber, a pigment, a filler or the like.

<Detachment Coat Layer>

The detachment coat layer 14 is a layer formed of a composition for forming a coat layer that contains an aqueous polyester-based resin having an acid value of 10 KOHmg/g or more.

The detachment coat layer 14 preferably has a thickness of 0.01 to 3 μm, more preferably 0.03 to 1 μm, and even more preferably 0.05 to 0.5 μm from the viewpoint of deinking properties (removability of a printing ink) at the time of the alkaline-immersion.

The composition for forming a detachment coat layer, which is a material for forming the detachment coat layer 14, contains an aqueous polyester-based resin having an acid value of 10 KOHmg/g or more (hereinafter, also simply referred to as “aqueous polyester-based resin”).

The “aqueous polyester-based resin” means a polyester-based resin that dissolves in an aqueous solvent to take the form of an aqueous solution, or a polyester-based resin that is dispersed in an aqueous solvent as an emulsion to take the form of a water dispersion. Using such “aqueous” polyester-based resin can reduce an emission of a volatile organic compound at the time of application of the detachment coat layer 14. The aqueous solvent as used herein refers to a solvent that contains 60% by mass or more (upper limit: 100% by mass), preferably 70% by mass or more, more preferably 85% by mass or more of water, and most preferably 95% by mass or more of a water-based solvent.

Examples of a component other than water contained in the aqueous solvent include, but not limited to, an organic solvent that dissolves in water. Examples of the organic solvent that dissolves in water include, but not limited to, methanol, ethanol, isopropanol, butanol, acetone, methyl ethyl ketone, dimethylformamide, methyl cellosolve, tetrahydrofuran, and ethylene glycol mono-t-butyl ether.

In an aspect of the present disclosure, a small amount of an emulsifier, a surfactant or the like may be used in order to form a water dispersion in which the aqueous polyester-based resin is dispersed in water as an emulsion as long as an effect of the present disclosure is not impaired.

However, a low molecular weight component such as an emulsifier, a surfactant or the like that is localized in the detachment coat layer 14 may reduce the adhesiveness, possibly resulting in a decrease in the adhesion between the layers. From the viewpoint of preventing such phenomenon, the aqueous polyester-based resin is preferably a self-emulsifying aqueous polyester-based resin in an aspect of the present disclosure.

By employing a self-emulsifying aqueous polyester-based resin, an emulsion can be formed without using a low molecular weight component such as an emulsifier, a surfactant or the like that causes a decrease in the adhesion between the layers, thereby improving the adhesion strength between the layers of the resulting pressure sensitive adhesive label 10(20). The term “self-emulsifying” means that some hydrophilic group is chemically introduced into the skeleton of a resin, so that the resin itself has an emulsifying ability without requiring an addition of an emulsifier or a surfactant.

The aqueous polyester-based resin has an acid value of 10 KOHmg/g or more, preferably 15 KOHmg/g or more, more preferably 20 KOHmg/g or more, further preferably 30 KOHmg/g or more, furthermore preferably 40 KOHmg/g or more, and particularly preferably 50 KOHmg/g or more. When the aqueous polyester-based resin has an acid value less than 10 KOHmg/g, the detachment coat layer 14 will be inferior in deinking properties.

The acid value of the aqueous polyester-based resin as used herein is a value measured in accordance with JIS K 0070:1992.

The aqueous polyester-based resin has a glass transition temperature (Tg) of 0° C. or more and 70° C. or less, preferably 10° C. or more and 65° C. or less, more preferably 15° C. or more and 60° C. or less, and further preferably 20° C. or more and 55° C. or less. When the aqueous polyester-based resin has a glass transition temperature (Tg) less than 0° C., the pressure sensitive adhesive label 10(20) will be inferior in blocking resistance and will be consequently inferior in printability. When the aqueous polyester-based resin has a glass transition temperature (Tg) exceeding 70° C., the detachment coat layer 14 will be inferior in deinking properties.

The glass transition temperature (Tg) of the aqueous polyester-based resin herein is a value measured in accordance with JIS K 7121:2012, specifically, a value obtained by the method below.

The aqueous polyester-based resin preferably has a number average molecular weight (Mn) of 1,000 or more and 15,000 or less, more preferably 1,500 or more and 10,000 or less, and further preferably 2,000 or more and 5,000 or less from the viewpoint of improving the solubility or dispersibility in water and improving the adhesion between a resulting primer layer and the base material layer 16 and/or the pressure sensitive adhesive layer 15. When the aqueous polyester-based resin has a Mn within these relatively low molecular weight ranges, the solubility or dispersibility in water can be sufficiently high and the deinking properties can be improved, which is preferable.

In the present disclosure, the value of a number average molecular weight (Mn) is a value in terms of standard polystyrene measured by a gel permeation chromatography (GPC) method.

Specifically, it is a value measured in accordance with the method described below.

### (1) Number Average Molecular Weight (Mn)

A value in terms of standard polystyrene measured by using a gel permeation chromatography system (manufactured by Tosoh Corporation, product name “HLC-8020”) under the following conditions is used.

Columns: “TSK guard column HXL-H”, “TSK gel GMHXL (×2)” and “TSK gel G2000HXL” (all manufactured by Tosoh Corporation)
Column temperature: 40° C.
Developing solvent: tetrahydrofuran
Flow rate: 1.0 mL/min

### (2) Glass Transition Temperature (Tg)

The glass transition temperature (Tg) is measured in accordance with JIS K 7121:2012 at a temperature increase rate of 20° C. per minute using a differential scanning calorimeter (manufactured by TA Instruments Japan Inc., product name “DSC Q2000”).

Examples of the aqueous polyester-based resin to be used in an aspect of the present disclosure includes, but not limited to, a copolymer obtained by polycondensation of an alcohol component and a carboxylic acid component; and a modified product of the copolymer.

Examples of the modified product of the copolymer include, but not limited to, a polyurethane-modified polyester-based resin obtained by reaction of a polyisocyanate compound and a hydroxyl group at a terminal of a copolymer obtained by polycondensation of an alcohol component and a carboxylic acid component. In the present disclosure, such modified product of the aqueous polyester-based resin is also included in the “aqueous polyester-based resin”.

As the alcohol component, a polyhydric alcohol having two or more hydroxyl groups per molecule can be used.

Specific examples of the alcohol component include, but not limited to, glycols such as ethylene glycol, diethylene glycol, triethylene glycol, tetraethylene glycol. propylene glycol, dipropylene glycol, 1,4-butanediol, 1,3-butanediol, 2,3-butanediol, 1,2-butanediol, 3-methyl-1,2-butanediol, 1,2-pentanediol, 1,5-pentanediol, 1,4-pentanediol, 2,4-pentanediol, 3-methyl-4,5-pentanediol, 2,2,4-trimethyl-1,3-pentanediol, 1,6-hexanediol, 1,5-hexanediol, 1,4-hexanediol, 2,5-hexanediol, neopentyl glycol, and hydroxypivalic acid neopentyl glycol ester; polylactone diols obtained by adding a lactone such as F-caprolactone to the glycols above; polyesterdiols such as bis(hydroxyethyl) terephthalate; cyclic dihydric alcohols such as 1,3-cyclohexanedimethanol, 1,4-cyclohexanedimethanol, tricyclodecanedimethanol, hydrogenated bisphenol A, hydrogenated bisphenol F, spiroglycol, and dihydroxymethyltricyclodecane; an ethylene oxide adduct and a propylene oxide adduct of bisphenol A; trihydric or higher polyhydric alcohols such as glycerin trimethylolpropane, trimethylolethane, diglycerin, triglycerin, 1,2,6-hexanetriol, pentaerythritol, dipentaerythritol, sorbitol, and mannitol. These alcohol components may be used singly or in combination of two or more.

As the carboxylic acid component, a polybasic acid having two or more carboxyl groups per molecule can be used.

Specific examples of the carboxylic acid component include, but not limited to, dicarboxylic acids such as phthalic acid, isophthalic acid, terephthalic acid, naphthalene dicarboxylic acid, 4,4-diphenyldicarboxylic acid, diphenylmethane-4,4′-dicarboxylic acid, succinic acid, adipic acid, azelaic acid, sebacic acid, het acid, maleic acid, fumaric acid, itaconic acid, cyclohexane-1,3-dicarboxylic acid, cyclohexane-1,4-dicarboxylic acid. hexahydrophthalic acid, hexahydroisophthalic acid, hexahydroterephthalic acid, and methylhexahydrophthalic acid and anhydrides thereof; tricarboxylic acids such as trimellitic acid, pyromellitic acid, trimesic acid, methylcyclohexenetricarboxylic acid, hexahydrotrimellitic acid, and tetrachlorohexene tricarboxylic acid and anhydrides thereof; and tetracarboxylic acids such as 1,2,4,5-cyclohexanetetracarboxylic acid, 1,2,3,4-butanetetracarboxylic acid, 1,2,3,4-cyclobutanetetracarboxylic acid, 1,2,3,4-cyclopentanetetracarboxylic acid, and pyromellitic acid and anhydrides thereof. These carboxylic acid components may be used singly or in combination of two or more.

The aqueous polyester-based resin to be used in an aspect of the present disclosure preferably has a structural unit derived from a polybasic acid having three or more carboxyl groups per molecule, more preferably a structural unit derived from a tricarboxylic acid or an anhydride of a tricarboxylic acid from the viewpoint of adjusting the acid value to a value within the above-described ranges.

In addition, the aqueous polyester-based resin to be used in an aspect of the present disclosure is preferably an aqueous polyester-based resin that contains a carboxyl group from the same viewpoint as described above.

(Particle)

The composition for forming a detachment coat layer may contain a particle for the purpose of improving slipperiness or the like.

The particle may be either an inorganic particle or an organic particle as long as the particle is water dispersible. Examples of the inorganic particle include, but not limited to, zirconia, silica, titanium dioxide, kaolin, alumina, titania, zeolite, calcium carbonate, barium sulfate, magnesium hydroxide, calcium phosphate, glass, mica, and talc. Examples of the organic particle include, but not limited to, an acrylic-based resin particle such as polymethylmethacrylate, a polystyrene-based particle, a styrene-acrylic based resin particle, and a polycarbonate-based particle. Among them, silica is preferred.

The particle content of the composition for forming a detachment coat layer is appropriately set in order to achieve a desired purpose (for example, an improvement in slipperiness). For example, the particle content is 0.1 parts by mass or more and 10 parts by mass or less per 100 parts by mass of the aqueous polyester-based resin.

The particle may have an average particle diameter appropriately set in consideration of a desire purpose. For example, when the purpose is an improvement in blocking resistance, the average particle diameter is preferably 0.1 to 1 μm, and more preferably 0.3 to 0.6 μm. The average particle diameter as used herein refers to a volume-based average particle diameter unless otherwise specified. For example, the average particle diameter can be obtained by measuring a dispersion liquid of the particle with a Coulter counter particle size distribution analyzer (TA-II model manufactured by Beckman Coulter, Inc.) using 50-μm apertures.

(General-Purpose Additive, Another Resin Component)

The composition for forming a detachment coat layer to be used in an aspect of the present disclosure may contain a general-purpose additive such as an antioxidant except for the aqueous polyester-based resin and the particle described above as long as an effect of the present disclosure is not impaired.

<Base Material Layer>

A base material to be used for the base material layer 16 may be any type of base material. Examples thereof include, but not limited to, a synthetic paper having a void therein and films made of polyolefin-based resins such as polyethylene, polypropylene, and olefin-based copolymers; polyester-based resins such as polyethylene terephthalate, and polyethylene naphthalate; polystyrene-based resins; polyvinyl chloride-based resins; acrylic-based resins; polycarbonate-based resins; polyamide-based resins; and fluorine-based resins such as polytetrafluoroethylene as well as a mixture or a layered product of these resins. The base material may have properties appropriately selected. It can also be selected whether the pressure sensitive adhesive label 10(20) is to be recycled either in a state of being attached to a container or in a state of having been peeled off from a container in view of the relation between the properties of a container to which the pressure sensitive adhesive label 10(20) is attached and the properties of the base material.

In the case that the pressure sensitive adhesive label 10(20) is to be recycled together with its container (that is, the pressure sensitive adhesive label 10(20) is to be recycled while being attached to the container), it is preferable to use a similar kind of material having compatibility with the container, i.e., the adherend. For example, when the pressure sensitive adhesive label 10(20) is used by being attached to a PET bottle, the base material to be used for the base material layer 16 is preferably a polyester-based resin. In terms of the quality such as the mechanical properties and the like of a recycled resin, a resin base material of a polyester-based film particularly advantageously has a composition similar to that of the resin used for the PET bottle.

Examples of the resin base material to be used for the polyester-based film include, but not limited to, polyester-based resins such as polyethylene terephthalate, polybutylene terephthalate, and polyethylene naphthalate. One kind of or two or more kinds of these resin base materials may be appropriately selected and used depending on the type of the resin used in the PET bottle, i.e., the adherend so as to obtain a resin base material having compatibility with the resin used in the PET bottle.

The compatibility of the base material as used herein means that the base material will melt at a temperature for heating and melting the container and will be well mixed into a melted resin base material of the PET bottle and will not deteriorate the properties of a recycled product. When the resin base material of a PET bottle is a mixture of two or more resins having compatibility with each other, the resin of the resin base material layer 16 may be one of the resins of the resin mixture constituting the PET bottle. When a container is made of a resin other than polyester-based resins, the resin of the resin base material layer 16 may be appropriately selected and used so as to obtain a resin base material having compatibility with the resin constituting the container depending on the type of the resin constituting the container, in a similar way to the above.

The base material layer 16 may have a thickness appropriately selected depending on its intended use or the like, but generally it is preferably 25 μm or more and 100 μm or less. In a process for attaching the pressure sensitive adhesive label 10(20) to a container, there is a case that a labeling process for attaching the pressure sensitive adhesive label 10(20) to a container using a labeling device is provided from the viewpoint of productivity. By employing the thickness of the base material layer 16 of 25 μm or more, the pressure sensitive adhesive label 10(20) has excellent peelability from the release liner 30 in the labeling process. By employing the thickness of the base material layer 16 of 100 μm or less, the rewind length of a roll that is installed in the labeling device can be sufficiently long, and the frequency of replacement of the roll can be reduced, thereby improving the work efficiency. When the base material layer 16 is made of a resin base material, the base material layer 16 may be formed by any conventionally known method such as an extrusion method, a calendar method, a solution coating method, or a casting method.

According to the present disclosure, the base material layer 16 may be subjected to a surface treatment on one or both sides thereof, if desired, for the purpose of improving the adhesion of the base material layer 16 to the coat layer provided on a surface of the base material layer 16 or to the polyester-based pressure sensitive adhesive layer 15 provided on the opposite surface thereof. Examples of the surface treatment include, but not limited to, treatments for forming unevenness on a surface such as a sand blast method and a solvent treatment method; and treatments for oxidation of a surface such as corona discharge treatment, chromic acid treatment, flame treatment, hot air treatment, and ozone or ultraviolet irradiation treatment.

<Pressure Sensitive Adhesive Layer>

Next, the pressure sensitive adhesive layer 15 will be described. A pressure sensitive adhesive to be used for the pressure sensitive adhesive layer 15 may be appropriately selected for use from those that have conventionally been used as a pressure sensitive adhesive for a label. Examples thereof include, but not limited to, acrylic-based pressure sensitive adhesives, rubber-based pressure sensitive adhesives, silicone-based pressure sensitive adhesives, polyurethane-based pressure sensitive adhesives, and polyester-based pressure sensitive adhesives. The pressure sensitive adhesive may have a composition appropriately selected depending on the properties of a container to which the pressure sensitive adhesive label 10(20) is attached, similarly to the base material layer 16. Accordingly, it can also be selected whether the pressure sensitive adhesive label 10(20) is to be recycled either in a state of being attached to the container or in a state of having been peeled off from the container.

However, similarly to the base material layer 16, in the case that the pressure sensitive adhesive label 10(20) is to be recycled with its container, the pressure sensitive adhesive layer 15 is preferably made of a material having high compatibility with the container. For example, when the pressure sensitive adhesive label 10(20) is used by being attached to a PET bottle, the pressure sensitive adhesive layer 15 is preferably made of a polyester-based pressure sensitive adhesive composition containing a polyester-based resin (A) as a main component.

The polyester-based resin (A), which is a main component of the polyester-based pressure sensitive adhesive composition, is obtained by copolymerizing, as constituent raw materials, copolymerization components including a polyvalent carboxylic acid compound (A1) and a polyol component (A2).

(Polyvalent Carboxylic Acid Compound (A1))

Examples of the polyvalent carboxylic acid compound (A1) include, but not limited to, aromatic dicarboxylic acids such as terephthalic acid, isophthalic acid, benzylmalonic acid, diphenic acid, 4,4′-oxydibenzoic acid, and naphthalene dicarboxylic acid; aliphatic dicarboxylic acids such as malonic acid, dimethylmalonic acid, succinic acid, glutaric acid, adipic acid, trimethyladipic acid, pimelic acid, 2,2-dimethylglutaric acid, azelaic acid, sebacic acid, fumaric acid, maleic acid, itaconic acid, thiodipropionic acid, and diglycolic acid; and divalent carboxylic acids including alicyclic dicarboxylic acids such as 1,3-cyclopentanedicarboxylic acid, 1,2-cyclohexanedicarboxylic acid, 1,3-cyclopentanedicarboxylic acid, 1,4-cyclohexanedicarboxylic acid, 2,5-norbornanedicarboxylic acid, and adamantane dicarboxylic acid. These may be used singly or in combination of two or more.

Among them, an aromatic dicarboxylic acid is preferably contained from the viewpoint of imparting cohesion.

(Polyol Component (A2))

Examples of the polyol component (A2) includes, but not limited to, dihydric alcohols including: aliphatic diols such as ethylene glycol, diethylene glycol, triethylene glycol, propylene glycol, dipropylene glycol, 1,3-propanediol, 2,4-dimethyl-2-ethylhexane-1,3-diol, 2-methyl-1,3-propanediol, 2,2-dimethyl-1,3-propanediol (neopentyl glycol), 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 3-methyl-1,5-pentanediol, and 2,2,4-trimethyl-1,6-hexanediol; alicyclic diols such as 1,2-cyclohexanedimethanol, 1,3-cyclohexanedimethanol, 1,4-cyclohexanedimethanol, spiroglycol, tricyclodecanedimethanol, adamantanediol, and 2,2,4,4-tetramethyl-1,3-cyclobutanediol; aromatic diols such as 4,4′-thiodiphenol, 4,4′-methylenediphenol, 4,4′-dihydroxybiphenyl, o-, m- and p-dihydroxybenzenes, 2,5-naphthalenediol, p-xylenediol, and ethylene oxide and propylene oxide adducts thereof. These may be used singly or in combination of two or more.

Among them, an aliphatic diol or an alicyclic diol is preferred in terms of excellent reactivity. Particularly preferably, the aliphatic diol is ethylene glycol, 1,3-propanediol, 2-methyl-1,3-propanediol, neopentyl glycol, 1,4-butanediol, 1,5-pentanediol or 1,6-hexanediol. Particularly preferably, the alicyclic diol is 1,2-cyclohexanedimethanol, 1,3-cyclohexanedimethanol, or 1,4-cyclohexanedimethanol.

The blending ratio of the polyvalent carboxylic acid compound (A1) and the polyol component (A2) is preferably 1 to 2 equivalents of, particularly preferably 1.1 to 1.7 equivalents of the polyol component (A2), per 1 equivalent of the polyvalent carboxylic acid compound (A1). When the content ratio of the polyol component (A2) is too low, the acid value increases and thereby it tends to be difficult to obtain a high molecular weight polymer. When the content ratio of the polyol component (A2) is too high, the yield tends to decrease.

The polyester-based resin (A) is produced by selecting the polyvalent carboxylic acid compound (A1) and the polyol component (A2) as desired and subjecting them to a polycondensation reaction in the presence of a catalyst by a known method.

The pressure sensitive adhesive to be used for the pressure sensitive adhesive layer 15 may contain an additive such as a hydrolysis inhibitor, a softener, an ultraviolet absorber, a stabilizer, an antistatic agent, or a tackifier as long as an effect of the present disclosure is not impaired.

The pressure sensitive adhesive layer 15 has any thickness. For example, the thickness thereof may be 5 μm or more and 100 μm or less, or 10 μm or more and 50 μm or less.

<Release Liner 30>

As illustrated in FIGS. 1 and 2, the release liner 30 includes the release base material layer 11 and the release agent layer 12.

As a release base material to be used for the release base material layer 11, any known release base material can be used. Examples thereof include, but not limited to, a resin material and paper. Examples of the resin material include, but not limited to, polyester and polyolefin. Examples of the paper include, but not limited to, a fine paper, a glassine paper, a laminated paper obtained by laminating a thermoplastic resin such as polyethylene.

The release liner 30 preferably has a thickness of 25 μm or more and 100 μm or less. By employing the thickness of the release liner 30 of 25 μm or more, the pressure sensitive adhesive label 10(20) can be suitable for punching processing. By employing the thickness of the release liner 30 of 100 μm or less, the release liner 30 can be excellent in peelability with respect to the pressure sensitive adhesive layer 15 in the labeling process.

Examples of a release agent constituting the release agent layer 12 include, but not limited to, a silicone-based release agent, a long-chain alkyl-based release agent, a fluorine-based release agent, and a rubber-based release agent. Among them, a silicone-based release agent is preferred. The release agent layer 12 generally has a thickness of about 0.01 μm or more and 5 μm or less.

<Manufacturing Method>

The pressure sensitive adhesive label 10(20) of the present disclosure may be manufactured in any method. For example, the pressure sensitive adhesive label 10(20) may be manufactured in a method in which a pressure sensitive adhesive roll or sheet is prepared and subjected to printing, a half die cutting process or weeding (removal of an unnecessary portion) as needed. A method for manufacturing the pressure sensitive adhesive roll or sheet may be, for example, (1) a method in which a pressure sensitive adhesive composition is applied on the release liner 30 to form the pressure sensitive adhesive layer 15, and the formed pressure sensitive adhesive layer 15 is attached to the base material layer 16, or (2) a method in which a pressure sensitive adhesive composition is applied on the base material layer 16 to form the pressure sensitive adhesive layer 15, and the formed pressure sensitive adhesive layer 15 is attached to the release liner 30.

The pressure sensitive adhesive composition may be applied to the base material layer 16 or to the release liner 30 by any method. For example, the application can be performed by a known coating device such as a roll coater, a knife coater, an air knife coater, a bar coater, a blade coater, a slot die coater, a lip coater, or a gravure coater.

The base material layer 16 may be provided in advance with the detachment coat layer 14 or the alkali-insoluble coat layer 17.

For each coat layer, a composition for forming a coat layer (a composition for forming a detachment coat layer or a composition for forming an alkali-insoluble coat layer, hereinafter collectively referred to simply as a composition for forming a coat layer) is prepared by mixing a resin, an additive as needed, and a solvent. The solvent is appropriately selected depending on the type of the resin. When the resin is a water-based polyester resin, the solvent is preferably, for example, water or an alcohol (e.g., ethanol, isopropanol, etc.), and more preferably water. The solvent may be used singly or in combination of two or more. When the resin is a urethane-modified polyester resin, the solvent is, for example, toluene, methyl ethyl ketone, or ethyl acetate.

Subsequently, the composition for forming a coat layer is applied to the base material layer 16 or to the coat layer to form a coat layer (the detachment coat layer 14 or the alkali-insoluble coat layer 17). The composition may be applied by any method. A conventionally known method, that is, e.g., a method in which the composition for forming a coat layer is applied on the base material layer 16 and dried to form a coat layer, may be employed. The application method may be any method and may be appropriately determined by selecting from, for example, coating devices such as a blade coater, an air knife coater, a rod blade coater, a bar blade coater, a gravure coater, a bar coater, a multi-roll coater, a roll coater, a reverse roll coater, a curtain coater, and a spray coater.

After the application of the composition for forming a coat layer, it may be subjected to a drying process. The drying conditions are appropriately set. For example, the drying is performed at 80° C. or more and 160° C. or less for 10 seconds or more and 60 seconds or less.

The present disclosure has been described with reference to the embodiments above. However, it is needless to say that the technical scope of the present disclosure is not limited to the scope described in the embodiments above. It will be apparent to those skilled in the art that various modifications and improvements can be made to the embodiments. It is also apparent from the description of the claims that such modifications or improvements are included in the technical scope of the present disclosure.

### EXAMPLES

The present disclosure will be described in more detail by the following examples, but the following examples shall not limit the present disclosure in any way. When the terms “part” and “%” are used in the examples below, they represent “part by mass” and “% by mass”, respectively, unless otherwise specified. Operations below are performed at room temperature (25° C.) unless otherwise specified.

### Example 1

As a composition for forming a detachment coat layer, a self-emulsifying aqueous polyester-based resin solution (solid content: 25% by mass, viscosity: 10 mPa-s (20° C.), an aqueous solvent, a polyester-based resin that has an acid value of 50 KOHmg/g, a molecular weight of 3,000 and, a Tg of 46° C. and contains a carboxylic group) was used. The composition for forming a detachment coat layer was applied on a polyethylene terephthalate film (a base material layer) having a thickness of 50 μm by a bar coater so as to have a dry film thickness of 0.06 μm and then dried. On the obtained detachment coat layer, a composition for forming an alkali-insoluble coat layer that is obtained by: mixing a urethane-modified polyester resin (manufactured by TOYOBO CO., LTD., VYLON UR-8200) with 3 parts by mass of a crosslinking agent (hexamethylene diisocyanate) per 100 parts by mass of the resin solid content; and diluting this mixture with toluene, was applied by a bar coater so as to have a dry film thickness of 0.08 μm and then dried to form an alkali-insoluble coat layer.

Next, 2 parts by mass (solid content) of a crosslinking agent (manufactured by Tosoh Corporation, trade name “Coronate L”) and 40 parts by mass of ethyl acetate were added to and mixed with 100 parts by mass (solid content) of a polyester-based resin (manufactured by Mitsubishi Chemical Corporation, trade name “NP-110S50EO”) to prepare a pressure sensitive adhesive composition.

The obtained pressure sensitive adhesive composition was applied on a release liner (thickness: 88 μm) formed by a polyethylene laminated glassine paper and a silicone-based release agent applied on the polyethylene laminated glassine paper, by a knife coater so as to have a dry film thickness of 20 μm, and then dried at 90° C. for 1 minute to form a pressure sensitive adhesive layer.

A surface of the polyethylene terephthalate film on the opposite side of the detachment coat layer and the pressure sensitive adhesive layer formed on the release liner were adhered to each other and allowed to stand in a normal environment (at 23° C. and 50% RH) for 7 days to obtain a pressure sensitive adhesive label.

### Example 2

A pressure sensitive adhesive label was obtained in the same manner as in Example 1, except that a self-emulsifying aqueous polyester-based resin solution (solid content: 25% by mass, viscosity: 10 mPa-s (20° C.), an aqueous solvent, a polyester-based resin that has an acid value of 40 KOHmg/g, a molecular weight of 3,000, and a Tg of 52° C. and contains a carboxylic group) was used.

### Comparative Example 1

A pressure sensitive adhesive label was obtained in the same manner as in Example 1, except that a self-emulsifying aqueous polyester-based resin solution (solid content: 25% by mass, viscosity: 10 mPa-s (20° C.), an aqueous solvent, a polyester-based resin that has an acid value of 25 KOHmg/g, a molecular weight of 5,000, and a Tg of 85° C. and contains a carboxylic group) was used.

### Comparative Example 2

A pressure sensitive adhesive label was obtained in the same manner as in Example 1, except that a self-emulsifying aqueous polyester-based resin solution (solid content: 25% by mass, viscosity: 10 mPa-s (20° C.), an aqueous solvent, a polyester-based resin that has an acid value of 5 KOHmg/g, a molecular weight of 15,000, and a Tg of −20° C. and contains a carboxylic group) was used.

### Comparative Example 3

A pressure sensitive adhesive label was obtained in the same manner as in Example 1, except that a self-emulsifying aqueous polyester-based resin solution (solid content: 25% by mass, viscosity: 10 mPa-s (20° C.), an aqueous solvent, a polyester-based resin that has an acid value of 2 KOHmg/g, a molecular weight of 27,000, and a Tg of 64° C. and contains a carboxylic group) was used.

### Evaluation Method 1: Printability

Solid printing was performed with a printing press, an RI tester, and an ink, UV161 J black S (manufactured by T&K TOKA CO., LTD.). The ink was cured by UV irradiation with a high-pressure mercury lamp. Then, its adhesion to the detachment coat layer or the alkali-insoluble coat layer was evaluated by means of cellophane tape peeling. Specifically, a crosscut having 100 squares (10×10) with sides of 1 mm was formed, and a remaining print portion after the cellophane tape peeling was evaluated in accordance with the following criteria. The results are given in Table 1.
5: 91 to 100% remained.
4: 66 to 90% remained.
3: 41% to 65% remained.
2: 16 to 40% remained.
1: 0 to 15% remained.

### Evaluation Methods 2: Deinking Properties

Solid printing was performed on the samples obtained in Examples and Comparative examples with the printing press, the RI tester, and the ink, UV161 J black S (manufactured by T&K TOKA CO., LTD.). The ink was cured by UV irradiation with the high-pressure mercury lamp. Each sample was then cut into sample pieces having a size of 10 mm×10 mm. Five sample pieces of each sample were placed in one liter of a 1.5% by mass aqueous solution of sodium hydroxide (pH 13.6) at 70° C. and stirred. The time when all the print portions of the five sample pieces peeled off was recorded (up to 15 minutes) and evaluated according to the following criteria. The results are given in Table 1.
5: Print came away from all the five sample pieces within 5 minutes.
4: Print came away from all the five sample pieces within 15 minutes.
3: Print came away from a part of the five sample pieces within 15 minutes.
2: Print came away from none of the five sample pieces within 15 minutes, but print came away when the print surfaces were rubbed immediately after the five sample pieces were taken out from the solution.
1: Print came away from none of the five sample pieces within 15 minutes, and print did not come away when the print surfaces were rubbed immediately after the five sample pieces were taken out from the solution.

### Evaluation Method 3: Blocking Resistance

For each of the pressure sensitive adhesive labels obtained in Examples and Comparative examples, sample films were prepared by using a part of the layers of the sensitive adhesive label (sample film size: 50 mm×100 mm, sample film configuration: the detachment coat layer and the base material layer [polyethylene terephthalate]). For each of the pressure sensitive adhesive labels obtained in Examples and Comparative examples, ten sample films were stacked on each other in such a manner that the detachment coat layer of a sample film was in contact with the rear surface of the base material layer of the adjacent sample film, and allowed to stand in an 80% RH environment at 40° C. for 7 days with a load of a 40 g/cm² applied thereon. The blocking resistance was evaluated in accordance with the evaluation criteria below. The results are given in Table 1.
5: There is no sticking between the films.
4: There is almost no sticking between the films.
3: There is a little sticking between the films, but there is no problem.
2: Some sticking between the films is confirmed.
1: Strong sticking between the films is confirmed.

TABLE 1

| | | | | Comparative | Comparative | Comparative |
|---|---|---|---|---|---|---|
| | | Example 1 | Example 2 | Example 1 | Example 2 | Example 3 |
| Alkali-insoluble coat layer | | Urethane modified polyester | | | | |
| Detachment | Resin | Polyester | | | | |
| coat layer | | | | | | |
| | Acid value | 50 | 40 | 25 | 5 | 2 |
| | (KOHmg/g) | | | | | |
| | Tg (° C.) | 46 | 52 | 85 | −20 | 64 |
| | Mn | 3000 | 3000 | 5000 | 15000 | 27000 |

| | | | | | |
|---|---|---|---|---|---|
| Printability | 5 | 5 | 5 | 5 | 5 |
| Deinking properties | 5 | 5 | 2 | 3 | 1 |
| Blocking resistance | 5 | 5 | 5 | 1 | 5 |

As indicated above, the pressure sensitive adhesive labels of Examples 1 and 2 were excellent in printability and blocking resistance, and excellent in deinking properties in alkaline hot water at a low temperature (about 70° C.). On the other hand, Comparative example 1, for which a composition for forming a detachment coat layer that contains an aqueous polyester-based resin having a glass transition temperature Tg exceeding 70° C. was used, was inferior in deinking properties of the print portion. Comparative example 2, for which a composition for forming a detachment coat layer that contains an aqueous polyester-based resin having a glass transition temperature Tg less than 0° C. was used, was inferior in blocking resistance. Comparative example 3, for which a composition for forming a detachment coat layer that contains an aqueous polyester-based resin having an acid value less than 10 KOHmg/g was used, was also inferior in deinking properties of the print portion as in Comparative Example 1.

1. A pressure sensitive adhesive label, comprising:
a pressure sensitive adhesive layer,
a base material layer, and
a detachment coat layer in this order, wherein
the detachment coat layer is formed of a composition for forming a detachment coat layer that contains an aqueous polyester-based resin, and
the aqueous polyester-based resin has an acid value of 10 KOHmg/g or more, and a glass transition temperature Tg of 0° C. or more and 70° C. or less.

2. The pressure sensitive adhesive label according to claim 1, wherein the aqueous polyester-based resin has a number average molecular weight of 1,000 or more and 15,000 or less.

3. The pressure sensitive adhesive label according to claim 1, wherein the aqueous polyester-based resin has a carboxyl group.

4. The pressure sensitive adhesive label according to claim 1, further comprising:
an alkali-insoluble coat layer, wherein
the alkali-insoluble coat layer is on the detachment coat layer facing the base material layer.

5. The pressure sensitive adhesive label according to claim 4, wherein the alkali-insoluble coat layer is made of a urethane-modified polyester resin.

6. The pressure sensitive adhesive label according to claim 4, wherein the alkali-insoluble coat layer contains a crosslinked resin.
